(19) United States
(12) Patent Application Publication
(10) Pub. No.: US 2026/0129302 A1
(43) Pub. Date: May 7, 2026

(54) IMAGE PICKUP APPARATUS CAPABLE OF TRACKING SUBJECT THAT IS FOCUSABLE EVEN WITH NARROW ANGLE OF VIEW, OUT OF SUBJECTS RECOGNIZED IN WIDE-ANGLE IMAGE

(71) Applicant: CANON KABUSHIKI KAISHA, Tokyo (JP)

(72) Inventor: JUNICHI SAITO, Kanagawa (JP)

(21) Appl. No.: 19/374,070

(22) Filed: Oct. 30, 2025

(30) Foreign Application Priority Data
Nov. 6, 2024 (JP) 2024-194325

(51) Int. Cl. H04N 23/695; H04N 23/61; H04N 23/67; H04N 23/698

(52) U.S. Cl. CPC H04N 23/695; H04N 23/61; H04N 23/671; H04N 23/698

(57) ABSTRACT

An image pickup apparatus capable of tracking a subject focusable even with a narrow angle of view is provided. The image pickup apparatus includes a first image pickup unit obtaining a wide-angle image, a second image pickup unit obtaining an image having an angle of view narrower than an angle of view of the first image pickup unit, a pan and tilt apparatus holding the first image pickup unit and the second image pickup unit so that they are capable of rotating in pan and tilt directions, and a control unit that determines as a tracking target, based on range finding results of subjects recognized from an image obtained by the first image pickup unit, a subject existing within a distance range focusable by the second image pickup unit among the recognized subjects, and controls the pan and tilt apparatus so as to track the subject being the tracking target.

### BACKGROUND

### Field of the Technology

The present disclosure relates to an image pickup apparatus.

### Description of the Related Art

An image pickup apparatus having a tracking function that uses a pan and tilt mechanism to perform framing of a subject has been known. For example, in an image pickup apparatus to be used for photographing sporting events, wild animals, etc., a photographing direction is determined by remote control (remote operation), and photographing is carried out. Japanese Laid-Open Patent Publication (kokai) No. 2000-115621 has disclosed a technique that uses a mirror block and a pan motor to control a photographing range of a telephoto camera, based on the movement of a subject that has been detected by a wide-angle camera. In addition, Japanese Laid-Open Patent Publication (kokai) No. 2018-88647 has disclosed a technique, in which, in order to accurately detect eyes of a driver driving a car, the position of the eyes of the driver is detected from a wide-angle image, and based on the detection result, a telephoto camera is panned and tilted to capture a magnified image of the eyes of the driver.

In the technique disclosed in Japanese Laid-Open Patent Publication (kokai) No. 2000-115621, although the focus adjustment of the telephoto camera

has been described, it is assumed that the intended subject is capable of being photographed with the telephoto camera. In addition, in the technique disclosed in Japanese Laid-Open Patent Publication (kokai) No. 2018-88647, in the case of detecting the eyes of the driver, since the position of the driver and the position of the camera are known to some extent, there is no need to consider whether or not it is possible to focus the eyes of the driver with the telephoto camera.

However, in the case of photographing sporting events, when attempting to carry out photographing by a telephoto camera, with a camera such as that disclosed in Japanese Laid-Open Patent Publication (kokai) No. 2000-115621, the following issue will arise. In other words, even in the case where a subject is capable of being focused in a wide-angle image that has been obtained by performing pan and tilt control, it may not be possible to perform focusing on the telephoto camera side that is used to carry out actual photographing (main photographing) because, for example, the subject distance is too close, and a focused image (an in-focus image) may not be obtained.

### SUMMARY

The present disclosure provides an image pickup apparatus capable of tracking a subject that is focusable even with a narrow angle of view, out of subjects recognized in a wide-angle image.

Accordingly, an aspect of the present disclosure provides an image pickup apparatus comprising a first image pickup unit configured to obtain a wide-angle image, a second image pickup unit configured to obtain an image having an angle of view that is narrower than an angle of view of the first image pickup unit and is included in the angle of view of the first image pickup unit, a pan and tilt apparatus configured to hold the first image pickup unit and the second image pickup unit so that the first image pickup unit and the second image pickup unit are capable of rotating in a pan direction and a tilt direction, and at least one processor and/or circuit configured to function as a control unit that determines as a tracking target, based on range finding results of subjects recognized from an image obtained by the first image pickup unit, a subject that exists within a distance range that is focusable by the second image pickup unit among the recognized subjects, and controls the pan and tilt apparatus so as to track the subject that is the tracking target.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image pickup apparatus according to an embodiment of the present disclosure.

FIG. 2 is a schematic block diagram of the image pickup apparatus shown in FIG. 1.

FIG. 3 is a flowchart of a pan and tilt processing executed by the image pickup apparatus shown in FIG. 1.

FIG. 4 is a schematic block diagram of an image pickup apparatus according to a modification of the embodiment of the present disclosure.

### DESCRIPTION OF THE EMBODIMENTS

The present disclosure will now be described in detail below with reference to the accompanying drawings showing embodiments thereof.

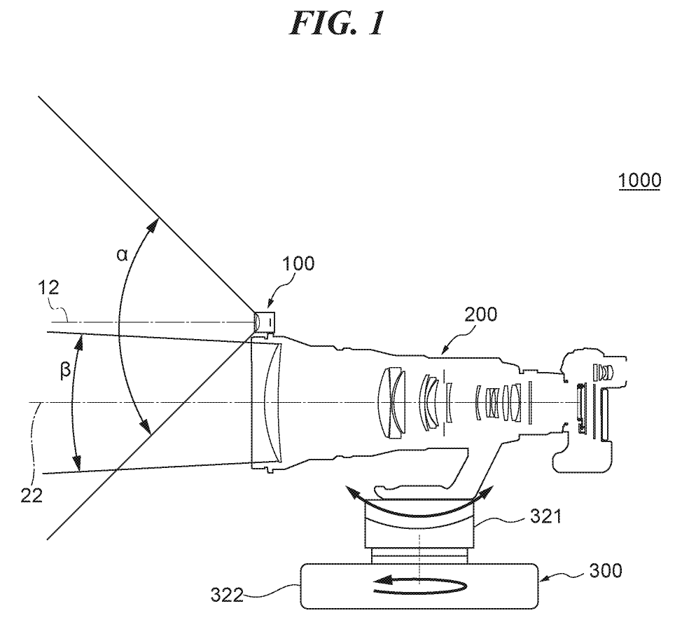

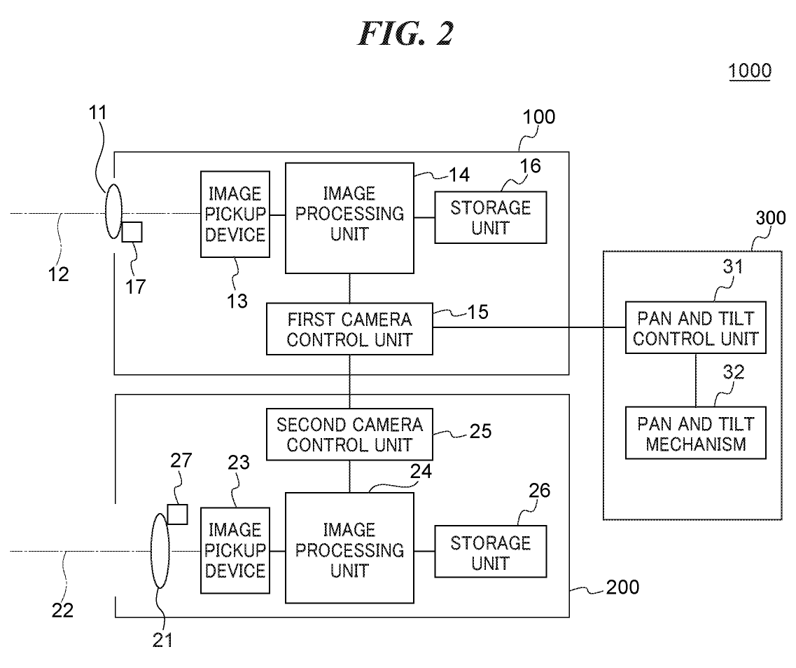

FIG. 1 is a schematic cross-sectional view of an image pickup apparatus 1000 according to an embodiment of the present disclosure. FIG. 2 is a schematic block diagram of the image pickup apparatus 1000 shown in FIG. 1. The image pickup apparatus 1000 includes a first camera 100 (a first image pickup unit), a second camera 200 (a second image pickup unit), and a pan and tilt apparatus 300.

The angle of view of the first camera 100 is an angle of view α. The angle of view of the second camera 200 is an angle of view β, which is narrower than the angle of view α. For example, the first camera 100 may be referred to as a wide-angle camera, and the second camera 200 may be referred to as a telephoto camera. An optical axis 12 of the first camera 100 and an optical axis 22 of the second camera 200 are parallel to each other, and the first camera 100 and the second camera 200 are always facing the same direction. The angle of view β is included in the angle of view α. In other words, an area that is capable of being picked up by the second camera 200 is also capable of being picked up by the first camera 100.

The pan and tilt apparatus 300 holds the first camera 100 and the second camera 200 integrally so that the first camera 100 and the second camera 200 are capable of rotating in a pan direction and a tilt direction. The pan and tilt apparatus 300 includes a pan and tilt control unit 31 and a pan and tilt mechanism 32 (see FIG. 2). The pan and tilt apparatus 300 uses a pan motor 322 and a tilt motor 321 that are included in the pan and tilt mechanism 32 to pan and tilt the first camera 100 and the second camera 200 as shown by arrows.

Although not particularly limited, the rotation center of the tilt motor 321 has been set on the optical axis 22 of the second camera 200, and the rotation center of the pan motor 322 has been set near the front principal point of the second camera 200. As a result, the pan and tilt operation mainly applies only angle changes to the pan and tilt operation of the second camera 200, and it becomes possible to prevent unnecessary translation components from being applied.

As shown in FIG. 2, the first camera 100 includes a wide-angle optical system 11, an image pickup device 13 (an image sensor 13), an image processing unit 14, a first camera control unit 15, and a storage unit 16. The wide-angle optical system 11 includes a focus mechanism 17. The second camera 200 includes an optical system 21, an image pickup device 23 (an image sensor 23), an image processing unit 24, a second camera control unit 25, and a storage unit 26. The optical system 21 includes a focus mechanism 27.

The first camera 100 is a so-called digital camera that converts a light beam that passes through the wide-angle optical system 11 and forms an image on the image pickup device 13 into image signals by a photoelectric conversion, and obtains a wide-angle image that has been subjected to various kinds of image processing in the image processing unit 14.

Based on the image signals that have been obtained by the image pickup device 13, range finding of the recognized subject and the focus driving operation of the focus mechanism 17 are carried out by the first camera control unit 15. In addition, the first camera control unit 15 has a function of calculating predicted range finding of the subject based on a history of the obtained range finding result of the subject. The first camera 100 is also capable of saving (recording), in the storage unit 16, the image signals that have been processed in the image processing unit 14. The case where the first camera 100 saves an image will be described below.

The second camera 200 is a so-called digital camera in which a light beam that forms an image on the image pickup device 23 via the optical system 21, which has a narrower angle of view than the wide-angle optical system 11, is converted into image signals by a photoelectric conversion, and various kinds of image processing are performed in the image processing unit 24.

Based on the image signals that have been obtained by the image pickup device 23, range finding of the recognized subject and the focus driving operation of the focus mechanism 27 are carried out by the second camera control unit 25.

It should be noted that the image pickup device 23 may have the number of pixels, which is higher than the number of pixels of the image pickup device 13, and the optical system 21 may have a resolving power, which is higher than a resolving power of the wide-angle optical system 11. In this case, the second camera 200 is capable of obtaining a clearer and higher resolution image than the first camera 100.

In the pan and tilt apparatus 300, based on recognition information and range finding information of the subject that have been obtained by the first camera control unit 15, the pan and tilt control unit 31 drives the pan and tilt mechanism 32 so as to track a main subject.

Since the first camera 100 is a camera with a wide angle of view, in a normal photographing scene, the influence of the translation component caused by the rotation center of the pan and tilt being shifted from the wide-angle optical system 11 is small and is capable of being ignored. The pan and tilt operation makes it possible to change the direction while maintaining the relationship between the optical axis 12 of the first camera 100 and the optical axis 22 of the second camera 200, which are parallel to each other.

In the image pickup apparatus 1000, the first camera 100 and the second camera 200 always face the same direction, but the present disclosure is not limited to such a configuration. Even in the case where the pan and tilt operation is performed, it is only necessary that the angle of view α of the wide-angle optical system 11 includes the angle of view β of the optical system 21. The image pickup apparatus 1000 is an image pickup apparatus whose main purpose is to save images that have been photographed (captured) by the second camera 200. The main role of the first camera 100 is to provide the recognition result and the range finding result of the main subject, for the pan and tilt apparatus 300 to track and drive the main subject.

The second camera 200 is capable of saving, in the storage unit 26, the image signals that have been processed in the image processing unit 24. The second camera control unit 25 is capable of referring to the subject recognition result and the range finding result obtained from the first camera control unit 15. In addition, the first camera control unit 15 is capable of referring to the subject recognition result and the range finding result obtained from the second camera control unit 25. In other words, the first camera control unit 15 and the second camera control unit 25 are capable of referring to each other's information.

It should be noted that the focal length of the optical system 21 of the second camera 200 is longer than that of the wide-angle optical system 11 of the first camera 100, but the present disclosure is not limited to this configuration, and any optical system is capable of being used as long as it is capable of covering a range of angle of view required by a photographer.

The first camera control unit 15 is capable of storing a history of the range finding result, and by performing an extrapolation calculation from the history of the range finding result, it is possible to predict the range finding result at a time a predetermined number of frames ahead and obtain it as range finding prediction information. The pan and tilt operation using this range finding prediction information will be described below.

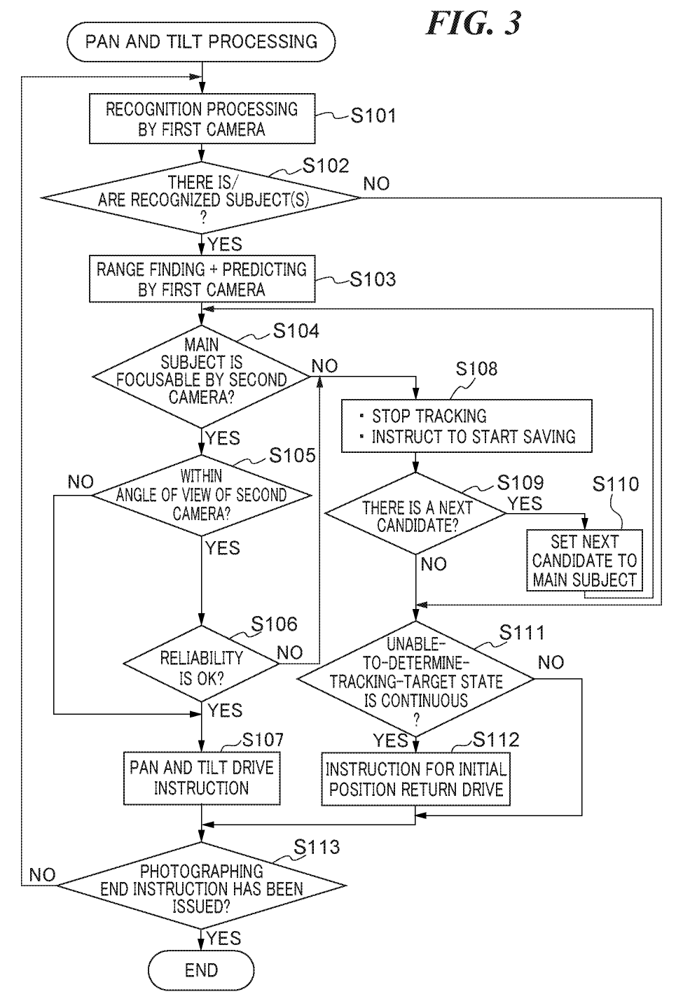

FIG. 3 is a flowchart of a pan and tilt processing executed by the image pickup apparatus 1000 shown in FIG. 1. This pan and tilt processing is started when the main power supply of the image pickup apparatus 1000 is turned on. Specifically, at a time point when the first camera 100, the second camera 200, and the pan and tilt apparatus 300 are activated, and the first camera control unit 15 and the second camera control unit 25 have become a state where they are able to communicate with each other, the pan and tilt processing is started.

The pan and tilt processing is executed by a control means. The first camera control unit 15, the second camera control unit 25, and the pan and tilt control unit 31 work together (cooperate with each other) to function as the control means (a control unit). It should be noted that each of the first camera control unit 15, the second camera control unit 25, and the pan and tilt control unit 31 is realized by a central processing unit (a CPU) (not shown) thereof loading a corresponding program into a corresponding random-access memory (a corresponding RAM) (not shown) and executing it. The corresponding program has been stored in a read only memory (a ROM) (not shown) or the like within each of the first camera 100, the second camera 200, and the pan and tilt apparatus 300.

As shown in FIG. 3, in a step S101, the first camera control unit 15 causes the first camera 100 to perform picking up of one frame (perform capturing of one frame), and further recognizes subject(s) from the output of the image processing unit 14. In the case where one subject has been recognized, the first camera control unit 15 determines the recognized one subject as “a main subject”. In the case where a plurality of subjects have been recognized, the first camera control unit 15 determines one of the plurality of subjects have been recognized as the main subject, and further performs the prioritization of the subjects other than the main subject (sub-subjects), and determines the subject that is capable of becoming the next main subject. For example, priorities are assigned depending on whether a face has been detected, whether a moving subject has been detected, and so on.

In a step S102, the first camera control unit 15 determines whether or not there is/are subject(s) that has/have been recognized in the step S101. In the case of being determined that subject(s) has/have not been recognized in the current frame (NO in the step S102), the first camera control unit 15 proceeds to a step S111. On the other hand, in the case of being determined that subject(s) has/have been recognized in the current frame (YES in the step S102), the first camera control unit 15 proceeds to a step S103.

In the step S103, the first camera control unit 15 of the first camera 100 performs range finding for the subject(s) that has/have been recognized in the step S101. As a result, the first camera control unit 15 obtains subject distances of the main subject and any sub-subjects present. In addition, in the case where the photographed frame (the captured frame) is one of second and subsequent frames (is the second frame or later), the first camera control unit 15 predicts the range finding result(s) of the subject(s) in one of next and subsequent frames (in the next frame or later) based on the history of the range finding results that have been obtained up to the previous frame and the range finding result that has been obtained this time (the range finding result that has been obtained in the current frame), and retains it/them as range finding prediction information. The range finding prediction information is stored in the storage unit 16 or a memory (not shown).

In a step S104, the first camera control unit 15 determines whether or not the main subject is capable of being focused by the focus mechanism 27 of the second camera 200, based on the range finding information and the range finding prediction information that have been obtained in the step S103. Specifically, in the case where the main subject is capable of being focused (is focusable) in the current frame and is predicted to be focusable in the next frame, it is determined that the main subject is focusable. On the other hand, in the case where the main subject is not capable of being focused (is not focusable) in the current frame or in the case of being predicted that the main subject will not be capable of being focused in the next frame (will not be focusable in the next frame), it is determined that the main subject is not focusable. In the case of being determined that the main subject is focusable (YES in the step S104), the first camera control unit 15 proceeds to a step S105, and on the other hand, in the case of being determined that the main subject is not focusable (NO in the step S104), the first camera control unit 15 proceeds to a step S108.

In the step S105, the first camera control unit 15 determines whether or not the main subject that has been recognized by the first camera 100 is within the angle of view of the second camera 200. This is to determine whether or not the main subject has become a state where the main subject is also capable of being recognized by the second camera 200 through the pan and tilt operation that will be described below.

In the case of being determined that the main subject that has been recognized by the first camera 100 is within the angle of view of the second camera 200 (YES in the step S105), the first camera control unit 15 proceeds to a step S106, and on the other hand, in the case of being determined that the main subject that has been recognized by the first camera 100 is not within the angle of view of the second camera 200 (NO in the step S105), the first camera control unit 15 proceeds to a step S107. Therefore, the step S106 is skipped and the processing proceeds to the step S107 until the second camera 200 becomes able to recognize the main subject through the pan and tilt operation.

In the step S106, the first camera control unit 15 determines the reliability of the range finding results (the range finding information and the range finding prediction information) that have been obtained in the step S103. Specifically, the first camera control unit 15 causes the second camera control unit 25 to perform range finding or range finding prediction with respect to the same subject as that, which has been the target of range finding or range finding prediction in the step S103, compares the results of both, and determines whether or not a difference exceeds a predetermined value.

In other words, the first camera control unit 15 obtains a difference between the range finding result (including the range finding prediction result) of the subject recognized from the image obtained by the first camera 100 and the range finding result (including the range finding prediction result) of the subject recognized from the image obtained by the second camera 200. Then, in the case where at least one of the difference between the range finding results or the difference between the range finding prediction results exceeds a predetermined value, since it is capable of being determined that the range finding result and the like obtained by the first camera 100 are unreliable, the first camera control unit 15 proceeds to the step S108. In this case, even if a subject exists within a distance range that is capable of being focused (is focusable) by the second camera 200, the subject will not be determined as a tracking target, so that the accuracy of determining the tracking target is capable of being improved. On the other hand, in the case where both the difference between the range finding results and the difference between the range finding prediction results do not exceed the predetermined value, the first camera control unit 15 proceeds to the step S107.

It should be noted that the determination may be made by weighting the range finding result and the range finding prediction result that have been obtained by the second camera 200. In addition, even in the case where the difference exceeds the predetermined value, the following processing may be performed.

In other words, the first camera control unit 15 instructs the second camera control unit 25 to cause to first move the focus mechanism 27 of the optical system 21 of the second camera 200 to a focus position that has been calculated by the first camera control unit 15, and then the second camera control unit 25 performs range finding. The focus position is a position indicated by the range finding result of the subject recognized from the image obtained by the first camera 100. After that, the first camera control unit 15 performs the obtainment of the difference again. In other words, the first camera control unit 15 compares again the range finding result that has been obtained again with the range finding result that has been obtained by the first camera control unit 15, and performs determining the reliability by comparing the difference with the predetermined value. This increases the accuracy of the determination.

In the step S107, the first camera control unit 15 determines the main subject as the tracking target, and causes to start tracking of the main subject. For this purpose, the first camera control unit 15 notifies the pan and tilt control unit 31 of main subject position information for pan and tilt control. The pan and tilt control unit 31 drives and controls the pan and tilt mechanism 32 so that the latest main subject is captured at the center of the screen of the second camera 200.

Therefore, among the subjects recognized from the image obtained by the first camera 100, the subject that exists within the distance range that is focusable by the second camera 200 is determined to be the tracking target, and the pan and tilt apparatus 300 is controlled so as to track the subject that is the tracking target.

It should be noted that the main subject is not limited to being captured at the center of the screen, and the drive control may be performed so that the main subject is capable of being positioned in the entire screen including the main subject with a composition balance desired by the user.

In the step S108, in the case where the main subject that has become the tracking target exists (in the case where the main subject is being tracked), the first camera control unit 15 stops tracking of the main subject. Strictly speaking, the first camera control unit 15 instructs the pan and tilt control unit 31, which then controls the pan and tilt mechanism 32 to stop driving for tracking of the main subject. For example, in the case where the pan and tilt control has been performed by the pan and tilt control unit 31 in the previous frame, the pan and tilt control for tracking the main subject that has become the tracking target in the previous frame is temporarily stopped. In this case, the pan and tilt mechanism 32 does not return to the initial position, but stops at the drive position at that time point.

For example, in the case where the first camera control unit 15 has predicted that the main subject that is being tracked will be out of the distance range that is focusable by the second camera 200, the first camera control unit 15 transitions from the step S104 to the step S108, and stops tracking of the subject. As a result, an unnecessary pan and tilt operation is suppressed.

The pan and tilt mechanism 32 is stopped because a focused image (an in-focus image) is not capable of being obtained even if the pan and tilt control for tracking the main subject that has been determined to be unfocusable is continued. It should be noted that the stopped pan and tilt mechanism 32 will remain in place (remain stopped) until a subject that is the tracking target is newly determined in the subsequent step S107 or an instruction for initial position return drive (a step S112) that will be described below is issued.

It should be noted that in the case of transitioning from the step S106 to the step S108, even if a subject exists within the distance range that is focusable by the second camera 200, the subject will not be determined as the tracking target.

Furthermore, in the step S108, in the case where saving of the photographed image captured by the first camera 100 has not been started, the first camera control unit 15 instructs the first camera control unit 15 to start saving the photographed image captured by the first camera 100 in the storage unit 16. Considering that a good image that is in an in-focus state is not capable of being obtained with the second camera 200, this saving of the photographed image captured by the first camera 100 is useful for saving an image, for example, at a decisive moment focused, which is not as high resolution as the second camera 200 but has a wide angle.

It should be noted that here, although a configuration has been described in which the saving of the photographed image captured by the first camera 100 is immediately performed when it is predicted in the step S104 that the main subject will become unfocusable, the present disclosure is not limited to this configuration. For example, the saving of the photographed image captured by the first camera 100 may be performed only in the case where the photographing of the main subject is successful over a predetermined number of frames. It should be noted that once the saving of the photographed image captured by the first camera 100 has started, the saving of the photographed image captured by the first camera 100 may be continued until the subject that is the tracking target becomes out of the angle of view of the second camera 200.

In a step S109, the first camera control unit 15 determines whether or not there is a next candidate for the main subject (a next candidate that becomes the main subject), that is, whether or not there is a subject other than the subject that has been determined to be unfocusable in the step S104. In the case of being determined that there is no next candidate (NO in the step S109), the first camera control unit 15 proceeds to the step S111. On the other hand, in the case of being determined that there is a next candidate (YES in the step S109), the first camera control unit 15 proceeds to a step S110.

In the step S110, the first camera control unit 15 newly sets the next candidate that has been determined in the step S109 as the main subject. It should be noted that in the case where there are a plurality of next candidates, the first camera control unit 15 newly sets, as the main subject, the sub-subject with the highest priority among the plurality of next candidates. When the setting is completed, the first camera control unit 15 returns to the step S104.

In the case of proceeding to the step S107 via the step S110 and the step S104, a new tracking target is determined. Therefore, after the first camera control unit 15 has stopped tracking of the subject that is the tracking target, in the case where there is another subject within the distance range that is focusable by the second camera 200 among the recognized subjects, the first camera control unit 15 newly determines the another subject to be the tracking target (the first camera control unit 15 determines the another subject to be a new tracking target).

In the step S111, the first camera control unit 15 determines whether or not a state in which the subject that is the tracking target is not capable of being determined is continuous over a predetermined number of frames. This occurs, for example, when a subject that is focusable by the second camera 200 and is highly reliable is not recognized. In the case of being determined that the state in which the subject that is the tracking target is not capable of being determined is not continuous over the predetermined number of frames (NO in the step S111), the first camera control unit 15 proceeds to a step S113. On the other hand, in the case of being determined that the state in which the subject that is the tracking target is not capable of being determined is continuous over the predetermined number of frames (YES in the step S111), the first camera control unit 15 proceeds to the step S112.

In the step S112, the first camera control unit 15 instructs the pan and tilt control unit 31 to start control for returning the pan and tilt mechanism 32 to the initial position (to start the initial position return drive). At the time point of transitioning to the step S112, since the state in which the subject that is the tracking target is not capable of being determined is continuous, the pan and tilt mechanism 32 has already been stopped. Therefore, the pan and tilt mechanism 32 is driven to the initial position, which is a predetermined pan and tilt position. The initial position is, for example, a position where a pan angle and a tilt angle become zero (the position shown in FIG. 1).

After the step S112 or the step S107, the first camera control unit 15 proceeds to the step S113. In the step S113, the first camera control unit 15 determines whether or not an instruction to end photographing (a photographing end instruction) has been issued. In the case of being determined that a photographing end instruction has not been issued (NO in the step S113), the first camera control unit 15 returns to the step S101. On the other hand, in the case of being determined that a photographing end instruction has been issued (YES in the step S113), the first camera control unit 15 ends the pan and tilt processing shown in FIG. 3.

It should be noted that in the case of returning to the step S101, a series of operations from the photographing of the next frame onwards is repeated. Then, when the subject that is the tracking target is newly determined in the step S107, driving of the pan and tilt mechanism 32 for tracking is started. Therefore, in the case where the state in which the subject that is the tracking target is not capable of being determined is continuous over the predetermined number of frames, the first camera control unit 15 returns the pan and tilt mechanism 32 to the initial position, and keeps the pan and tilt mechanism 32 waiting at the initial position until the subject that is the tracking target is determined.

It should be noted that in the step S112, the pan and tilt mechanism 32 is returned to the initial position, but the pan and tilt mechanism 32 may be driven to a predetermined position where the next main subject is more easily recognized.

According to the present embodiment, based on the range finding results of the subjects recognized from the image obtained by the first camera 100, only the subject among the recognized subjects that is focusable by the second camera 200 or is predicted to be focusable by the second camera 200 is determined to be the tracking target and is tracked. Therefore, it is possible to track a subject that is focusable even with a narrow angle of view among subjects recognized in a wide-angle image.

In addition, in the case of having been predicted that the subject that is the tracking target will be out of the distance range that is focusable by the second camera 200, image saving by the first camera 100 is started. Therefore, even in a situation where it is difficult to successfully perform photographing (capture an image) with the second camera 200, it is possible to prevent missing a decisive moment.

In addition, in a situation where a focused image (an in-focus image) of the main subject is not capable of being obtained or in a situation where it is predicted that a focused image of the main subject is not capable of being obtained, it is possible to change the tracking target to be a new main subject from among the sub-subjects. This allows the second camera 200 to always photograph the subject in an in-focus state (to always capture an image of the subject in the in-focus state).

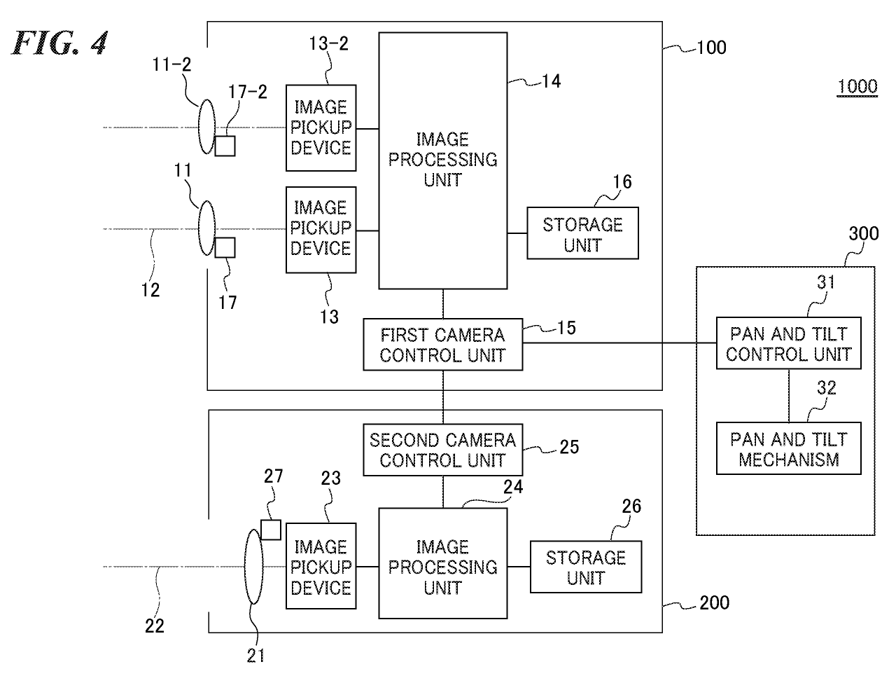

It should be noted that although the first camera 100 is provided with a pair of the wide-angle optical system 11 and the image pickup device 13, the present disclosure is not limited to this configuration. For example, as in a modification of the embodiment of the present disclosure shown in FIG. 4, the first camera 100 may be a stereo camera that includes two wide-angle optical systems and two image pickup devices.

FIG. 4 is a schematic block diagram of an image pickup apparatus 1000 according to the modification of the embodiment of the present disclosure. A first camera 100 included in the image pickup apparatus 1000 shown in FIG. 4 includes an image pickup device 13-2 and a wide-angle optical system 11-2 in addition to the configuration shown in FIG. 2. The wide-angle optical system 11-2 includes a focus mechanism 17-2.

In the case where the first camera 100 is a stereo camera, the range finding results of the subjects may be obtained by using parallax information of two wide-angle images that have been obtained by the image pickup device 13 and the image pickup device 13-2.

According to the present disclosure, it is possible to track the subject that is focusable even with the narrow angle of view among the subjects recognized in the wide-angle image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-194325, filed November 6, 2024, which is hereby incorporated by reference herein in its entirety.

What is claimed is:

1. An image pickup apparatus comprising:
a first image pickup unit configured to obtain a wide-angle image;
a second image pickup unit configured to obtain an image having an angle of view that is narrower than an angle of view of the first image pickup unit and is included in the angle of view of the first image pickup unit;
a pan and tilt apparatus configured to hold the first image pickup unit and the second image pickup unit so that the first image pickup unit and the second image pickup unit are capable of rotating in a pan direction and a tilt direction; and
at least one processor and/or circuit configured to function as a control unit that determines as a tracking target, based on range finding results of subjects recognized from an image obtained by the first image pickup unit, a subject that exists within a distance range that is focusable by the second image pickup unit among the recognized subjects, and controls the pan and tilt apparatus so as to track the subject that is the tracking target.

2. The image pickup apparatus according to claim 1, wherein
in a case of having been predicted based on a history of the range finding results that the subject that is the tracking target will be out of the distance range that is focusable by the second image pickup unit, the control unit stops tracking of the subject that is the tracking target.

3. The image pickup apparatus according to claim 2, wherein
after the control unit has stopped the tracking of the subject that is the tracking target, in a case where there is another subject within the distance range that is focusable by the second image pickup unit among the recognized subjects, the control unit determines the another subject to be a new tracking target, and controls the pan and tilt apparatus so as to track the another subject that is the new tracking target.

4. The image pickup apparatus according to claim 1, wherein
in a case of having been predicted based on a history of the range finding results that the subject that is the tracking target will be out of the distance range that is focusable by the second image pickup unit, the control unit causes to start saving of the image obtained by the first image pickup unit.

5. The image pickup apparatus according to claim 4, wherein
the saving of the image obtained by the first image pickup unit is continued until the subject that is the tracking target becomes out of the angle of view of the second image pickup unit.

6. The image pickup apparatus according to claim 1, wherein
the control unit obtains a difference between the range finding result of the subject recognized from the image obtained by the first image pickup unit and a range finding result of a subject recognized from an image obtained by the second image pickup unit, and in a case where the difference exceeds a predetermined value, even if a subject exists within the distance range that is focusable by the second image pickup unit, the control unit does not determine the subject as the tracking target.

7. The image pickup apparatus according to claim 6, wherein
in the case where the difference exceeds the predetermined value, the control unit causes to move a focus position by the second image pickup unit to a position indicated by the range finding result of the subject recognized from the image obtained by the first image pickup unit, and then performs obtainment of the difference again.

8. The image pickup apparatus according to claim 1, wherein
in a case where the control unit has stopped tracking of the subject that is the tracking target, the control unit stops the pan and tilt apparatus at that time point, and continues to stop the pan and tilt apparatus until the subject that is the tracking target is newly determined.

9. The image pickup apparatus according to claim 1, wherein
in a case where the pan and tilt apparatus is not positioned at a predetermined position and a state in which the subject that is the tracking target is not capable of being determined is continuous over a predetermined number of frames, the control unit returns the pan and tilt apparatus to the predetermined position, and keeps the pan and tilt apparatus waiting at the predetermined position until the subject that is the tracking target is determined.

10. The image pickup apparatus according to claim 1, wherein
the first image pickup unit is a stereo camera, and
the range finding results are obtained based on parallax information of two images obtained by the first image pickup unit.
